(19) United States
(12) Patent Application Publication
(10) Pub. No.: US 2012/0084116 A1
(43) Pub. Date: Apr. 5, 2012

(54) METHOD AND APPARATUS FOR DETERMINING WHETHER TO ALLOW CREATION OF A CONTENT CHANNEL

(76) Inventor: Sailesh Kumar Sathish, Tampere (FI)

(21) Appl. No.: 12/897,142

(22) Filed: Oct. 4, 2010

(51) Int. Cl. G06F 17/30

(52) U.S. Cl. 705/7.29

(57) ABSTRACT

An apparatus may include a content channel drafting module configured to provide for drafting of a content channel. A content channel comparison module may compare the content channel with existing content channels to determine a similarity factor. A channel creation determination module may determine whether or not to allow creation of the content channel based at least in part on the similarity factor. Thereby, creation of the content channel may be allowed in instances in which the similarity factor is less than a threshold correlation value and disallowed in instances in which the similarity factor exceeds the threshold correlation value. Further, when creation of a content channel is allowed, selection of a public channel status configured to allow sharing of the content channel may be disallowed in an instance in which the similarity factor exceeds a lower threshold correlation value.

### TECHNOLOGICAL FIELD

An example embodiment of the present invention relates generally to techniques for recommending content and, more particularly, relates to an apparatus, a method and a computer program product for determining whether or not to allow creation of a content channel.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

Some of the technologies which are becoming more popular are that of location based services and other personalized services. In this regard, some technologies may provide users of properly equipped mobile terminals with content which is specific to the present location of the user, present activity of the user, or other contextual information. Thus, for example, the user may be provided with weather information relating to the user's present location. In other instances the user may be provided with information such as Uniform Resource Locators (URLs) which relate to one or both of the user's interests and the user's present location along with other contextual characteristics. Thereby, content may be provided to the user automatically. This content may in some cases be displayed on the home screen of the mobile terminal.

### BRIEF SUMMARY

A method, apparatus and computer program product therefore provide for drafting of a new content channel which may be tailored to provide particular types of content which one or more users may be interested in.

In an example embodiment, an apparatus comprises at least one processor and at least one memory including computer program code, the at least one memory and the computer program code configured to, with the processor, cause the apparatus to provide for drafting a content channel comprising one or more content tags. The apparatus may compare the content channel with a plurality of existing content channels based at least in part on the content tags to determine a similarity factor. Further, the apparatus may determine whether or not to allow creation of the content channel based at least in part on the similarity factor.

In an additional example embodiment a method comprises providing for drafting a content channel comprising one or more content tags. Further, the method may include comparing the content channel with a plurality of existing content channels based at least in part on the content tags to determine a similarity factor. Additionally, the method may comprise determining via a processor whether or not to allow creation of the content channel based at least in part on the similarity factor.

In a further example embodiment a computer program product comprises at least one computer-readable storage medium having computer-executable program code portions stored therein, the computer-executable program code portions comprising program code instructions providing for drafting a content channel comprising one or more content tags. Additional program code instructions may compare the content channel with a plurality of existing content channels based at least in part on the content tags to determine a similarity factor. Further, the computer program product may include program code instructions for determining whether or not to allow creation of the content channel based at least in part on the similarity factor.

In a further example embodiment an apparatus comprises means providing for drafting a content channel comprising one or more content tags. Further, the apparatus may include means for comparing the content channel with a plurality of existing content channels based at least in part on the content tags to determine a similarity factor. Additionally, the apparatus may comprise means for determining whether or not to allow creation of the content channel based at least in part on the similarity factor.

In some embodiments creation of the content channel may be allowed in an instance in which the similarity factor is less than a threshold correlation value and disallowed in an instance in which the similarity factor exceeds the threshold correlation value. Further, a user may select a public channel status configured to allow sharing of the content channel or a private channel status configured to disallow sharing of the content channel. However, selection of the public channel status may be disallowed in an instance in which the similarity factor exceeds a lower threshold correlation value.

Further, subscription to one of the existing content channels, which may exist on a service provided by a content channel server, may be suggested in the instance in which the similarity factor exceeds the threshold correlation value. Also a context token may be selected which specifies an instance in which the content channel is active. Additionally, the content channel may be suggested for subscription in an instance in which the content channel is active. Further, in some embodiments the apparatus may comprise user interface circuitry configured to facilitate user control of at least some functions of the apparatus through use of a display, and cause at least a portion of a user interface of the apparatus to be displayed on the display to facilitate user control of at least some functions of the apparatus. Accordingly, embodiments of the present invention may provide a way to create new content channels which are not substantially similar to existing content channels.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to determine whether or not to allow creation of a content channel based at least in part on a similarity factor according to an example embodiment of the present invention; and

FIG. 3 illustrates a flowchart of the operations performed in determining whether or not to allow creation of a content channel based at least in part on a similarity factor according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

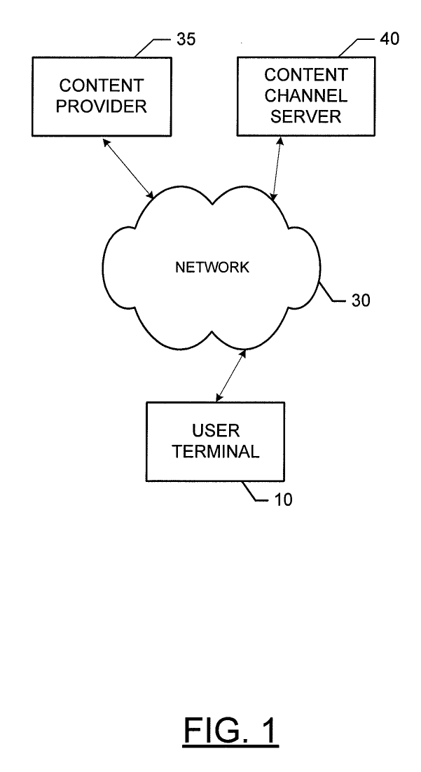

As indicated above, some embodiments of the present invention may be employed in methods, apparatuses and computer program products configured to provide for drafting of a content channel and allow for creation of the content channel in some instances. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a user terminal 10. The user terminal 10 may be any of multiple types of fixed or mobile communication and/or computing devices such as, for example, personal digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The user terminal 10 may be configured to output URL links and/or other types of content such as pictures, data, audio, or video. Thus, the system may additionally comprise one or more content providers 35 which provide the content to the user terminal 10. In some embodiments each of the content providers 35 may be embodied as a server, server bank or other computer or other computing device or node configured to provide content to the user terminal 10. Each content provider 35 may have any number of functions or associations with various services. As such, for example, each of the content providers 35 may be a platform such as a dedicated server (or server bank), or each of the content providers may be a backend server associated with one or more other functions or services. Thus, the content providers may provide various types and forms of content to the user terminal 10.

In some embodiments content may be delivered to the user terminal 10 through content channels which the user terminal may subscribe to in some embodiments. A content channel, as used herein, may refer to a collection of content which is selected based on specified criteria. For example, content channels may include content which relates exclusively to sports, news, etcetera. Thus, the system may additionally comprise a content channel server 40. In some embodiments the content channel server 40 may be embodied as a server, server bank or other computer or other computing device or node configured to store content channels for selection by the user of the user terminal 10. The content channel server 40 may have any number of functions or associations with various services. As such, for example, the content channel server 40 may be a platform such as a dedicated server (or server bank), or the content channel server may be a backend server associated with one or more other functions or services. Thus, content channel server 40 may provide a plurality of content channels for selection by the user of the user terminal 10. Further, in some embodiments, as will be explained below, one or both of the user terminal 10 and the content channel server 40 may provide for creation of new content channels.

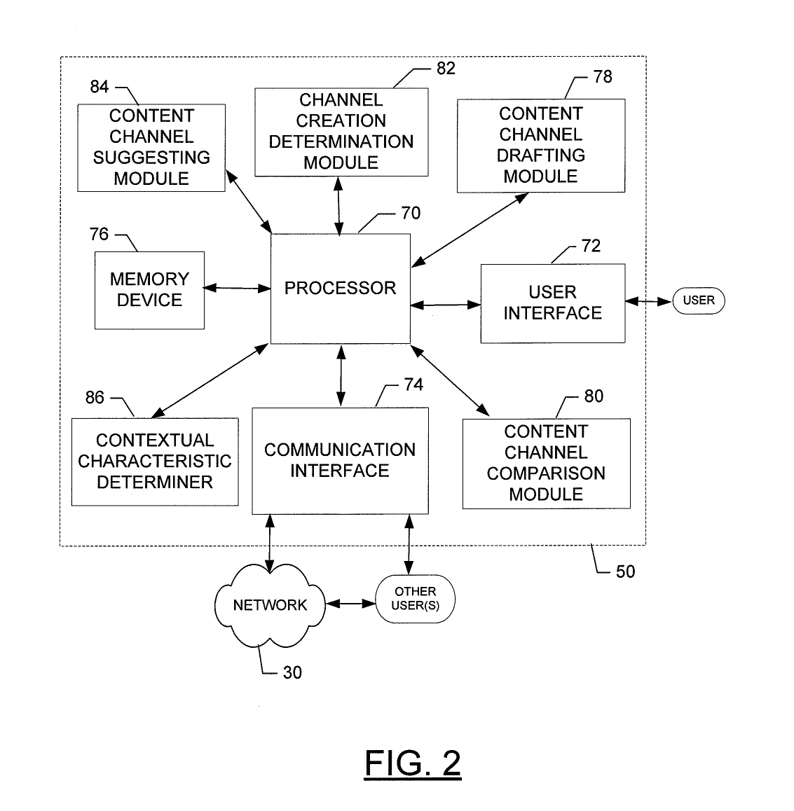

In an example embodiment, an apparatus 50 is provided that may be employed by devices performing example embodiments of the present invention. The apparatus 50 may be embodied, for example, as any device hosting, including, controlling, comprising, or otherwise forming a portion of the user terminal 10, the content providers 35, and/or the content channel server 40. However, embodiments may also be embodied on a plurality of other devices such as for example where instances of the apparatus 50 may be embodied on the network 30. As such, the apparatus 50 of FIG. 2 is merely an example and may include more, or in some cases less, than the components shown in FIG. 2.

With further regard to FIG. 2, the apparatus 50 may be configured to determine whether or not to allow creation of the content channel based at least in part on the similarity factor. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

As mentioned above, the apparatus 50 may, in some embodiments, be a user terminal or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a user terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

The processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor 70 may be configured to control one or more functions of one or more elements of the user interface 72 through computer program instructions (for example, software and/or firmware) stored on a memory accessible to the processor 70 (for example, memory device 76, and/or the like).

In some embodiments the apparatus 50 may further include a content channel drafting module 78. The processor 70 or other circuitry may be embodied as, include or otherwise control the content channel drafting module 78. The content channel drafting module 78 may be configured to provide for drafting a content channel. Providing for drafting a content channel, as used herein, refers to the process which occurs when building a content channel. Thus, providing for drafting may involve data entry on the user terminal 10 itself and/or receipt of this information at the content channel server 40 in some embodiments. A content channel may comprise a name and one or more content tags (e.g. noun tokens such as “tennis”) which denote the specific topic to which the content channel relates. In some embodiments the content channel may further be provided with a description for the channel.

Also, context tokens, which may specify instances in which the content channel is active, may be associated with the content channel during the drafting process. For example, the context tokens may specify certain locations, times of day, countries, languages, activities, etcetera at/during which the content channel is active and hence configured to provide content and/or be available for subscription. The content channel drafting module 78 may provide the user with a list of supported context tokens, and additionally the user may be provided with suggested values in some embodiments. Further, the user may specify whether the context tokens are public (e.g. whereby the context tokens would apply to all subscribers to the content channel) or private (e.g. whereby the context tokens would apply only to the user creating the content channel).

In some embodiments the apparatus 50 may further include a content channel comparison module 80. The processor 70 or other circuitry may be embodied as, include or otherwise control the content channel comparison module 80. The content channel comparison module 80 may be configured to compare the content channel which is being drafted (e.g. the “draft content channel”) with a plurality of existing content channels based at least in part on the content tags that characterize the content channels to determine a similarity factor. In one example embodiment the apparatus 50 may be embodied in the content channel server 40, and hence comparing may involve receiving and analyzing the draft content channel information at the content channel server. Existing content channels (e.g. those content channels which already exist) may each comprise respective content tags. As will be described below, it may be desirable to know how similar the draft content channel is to existing content channels. Accordingly, the content channel comparison module 80 may be used to compare the content tags of the draft content channel with the existing content channels.

In some embodiments the content channel comparison module 80 may further extract content tags from the description of the channel. Further, the content channel comparison module 80 may also add other similar content tags which are related to the selected content tags to build a language model relating to the draft content channel. The similar content tags may be sourced from a super language model built from a language database provided, for example, by an external service such as WIKIPEDIA®. The process of identifying similar content tags may involve identifying each content tag within a lattice within the model matrix and choosing all neighbors within that lattice point within a certain boundary. Thus, a sub-language model (hereinafter referred to as a language model of the content channel) may be built for the draft content channel.

The language model of the draft content channel (including the content tags) may then be compared to the language models of the existing content channels. In one embodiment the content channel comparison module may implement a matching process that determines a similarity factor (e.g. a distance metric, or match correlation) indicating the degree of similarity between the language model of the draft content channel and the language model of the existing content channels. The computation of the similarity factor may involve any methods available in the art. Thus, for example, in some embodiments a relatively high similarity factor may correspond with a relatively high degree of similarity between the language model of the draft content channel and the language model(s) of one or more of the existing content channels. In some embodiments the similarity factor produced by the content channel comparison module 80 may indicate the degree of similarity between the language model of the draft content channel and the language model of the most similar one of the existing content channels.

While the draft content channel may be fully drafted at this point, in some embodiments it may be desirable to not allow for creation of a new content channel based on the draft content channel. For example, if the draft content channel is substantially similar to one or more existing content channels, little or no benefit may be provided by the addition of the draft content channel to the existing content channels available for subscription. Further, creation of many similar content channels may result in dilution of the existing content channels, potentially resulting in an unwieldy user interface whereby it may be difficult for a user to identify and subscribe to desired content channels. Accordingly, it may be desirable to restrict the creation of content channels to those content channels which differ from existing content channels.

In this regard, in some embodiments the apparatus 50 may further include a channel creation determination module 82. The processor 70 or other circuitry may be embodied as, include or otherwise control the channel creation determination module 82. The channel creation determination module 82 may be configured to determine whether or not to allow creation of the draft content channel. In some embodiments the determination may be made based on the similarity factor. Providing for determining whether or not to allow creation may occur at either or both of the user terminal 10 or the content channel server 40 in some embodiments. In embodiments in which the determination is made at the content channel server 40, the content channel server may signal the determination to the user terminal 10.

In one embodiment the channel creation determination module 82 may allow creation of the content channel in instances in which the similarity factor is less than a threshold correlation value. Conversely, the channel creation determination module 82 may disallow creation of the content channel in an instance in which the similarity factor exceeds the threshold correlation value. In such embodiments a relatively higher correlation value may correspond with a relatively closer similarity. Thus, the threshold correlation value may be selected based on what degree of similarity is to be allowed between the draft content channel and the existing content channels. For example, selection of a relatively low threshold correlation value in the above-described embodiment would require relatively less similarity between the draft content channel and the existing content channel in order for the draft content channel to be created.

In some embodiments the apparatus 50 may be further configured to provide for selection of a public channel status configured to allow sharing of the content channel, or a private content channel status configured to disallow sharing of the content channel. For example, when a content channel has the private channel status, it may be available to only the creator of the content channel. Conversely, content channels with the public channel status may be available for subscription by more than one user. For example, the content channels with public channel status may be made available for a group of specified users or made available for all users. In some embodiments the apparatus 50 may require the user to enter a description for the content channel when the public channel status is selected. Thereby, other users may be provided with a description of the content channel such that they may decide whether to subscribe to the content channel based on the description.

In some embodiments of the apparatus 50, the content drafting module 78 may allow for selection of the public channel status or the private channel status during the drafting stage of the content drafting module. However, in other embodiments the channel creation determination module 82 may provide for selection of the public channel status or the private channel status. In such embodiments the channel creation determination module 82 may only provide for selection of the public channel status or the private channel status after determining that it will allow for creation of the content channel in one embodiment.

However, the channel creation determination module 82 may disallow selection of the public channel status in an instance in which the similarity factor exceeds a lower threshold correlation value in some embodiments. Thereby, for example, when the similarity factor is above the lower threshold correlation value, but below the threshold correlation value (e.g. the upper threshold correlation value), the channel creation determination module 82 may allow for creation of the content channel, but only allow for creation of the content channel with private channel status. In some embodiments the channel creation determination module 82 may thus create a channel with a private status that applies the selected channel name as a pseudonym for one or more of the existing content channels. Alternatively, or additionally, when the similarity factor is above the lower threshold correlation value, but below the upper threshold correlation value, the channel creation determination module 82 may allow the user to modify the draft content channel, for example by modifying the previously selected content tags. Then the content channel comparison module 80 may recalculate the similarity factor, and the channel creation determination module 82 may make a new determination as to whether or not to allow for creation of the content channel using the newly calculated similarity factor, as described above.

In some embodiments the apparatus 50 may further include a content channel suggesting module 84. The processor 70 or other circuitry may be embodied as, include or otherwise control the content channel suggesting module 80. The content channel suggesting module 80 may be configured to suggest content channels for subscription. For example, in instances in which the similarity factor exceeds the upper threshold correlation value, and hence creation of a new content channel is disallowed, the content channel suggesting module 84 may be configured to suggest subscription to one of the existing content channels instead. For example, the content channel suggesting module 84 may suggest the existing content channel with the highest correlation value. In such embodiments, if the user selects the suggested existing content channel for subscription, any context tokens selected during the drafting of the draft content channel may be applied to the selected existing content channel on a private basis, whereby they apply only to that user.

However, the content channel suggesting module 84 may also function to suggest content channels outside of the content channel drafting and creation process. For example, as described above, each content channel may include one or more context tokens specifying instances in which the content channel is active. The content channel suggesting module 84 may thus suggest a content channel when the content channel is active. For example, one or more suggested content channels may be displayed in a recommendation list on the user terminal 10.

Since there may be several content channels that may be of interest to the user at any given time, and because of screen size and user interface restrictions, it may not be possible to show all of the available content channels at one time. Thus, the content channel suggesting module 84 may select and suggest the content channels based on the extent of fulfillment of the context tokens. Further, for content channels with a private channel status and/or content channels which have been subscribed to, the content channel suggesting module 84 may actively monitor the context tokens associated therewith for fulfillment, and add the content channels to the recommendation list. Thereby, content channels that may have fallen out of the scope of the context tokens or deemed less important within the current context of the user/apparatus may be removed from the recommendation list.

In one embodiment the content channel suggesting module 84 may build a multi-dimensional context state table wherein each content channel in the table may include respective context tokens specifying the instances in which the content channel is active and current corresponding values of the context tokens. Thereby, as the current values of the context tokens change, the content channels which are active may change. Hence, the content channels which are suggested may be updated by the content channel suggesting module 84 over the course of time.

Further, in some embodiments an additional step may occur before a content channel is suggested. In this regard, in some embodiments available content (e.g. content relating to the content tags of a content channel and hence may be recommended by a content channel) may be identified prior to suggesting a content channel for subscription. In some embodiments the content may be provided by the content providers 35. For example, it may be desirable for the content channel to identify content available for recommendation before a content channel is suggested such that when a user subscribes to the content channel, content may be immediately available to the user. Thus, in some embodiments, content is identified prior to suggesting the content channel for subscription. Further, in one embodiment a table may be maintained of content channels which have been subscribed to. Thus, by way of example, the content channel server 40 may maintain a table of content channels which the user terminal 10 has subscribed to. When content is available for one or more of the content channels, as may be provided by the content provider 40, the table may be updated to indicate that those channels are active, and hence ready to provide content to the user terminal when appropriate, as will be described below.

Whether a content channel presently has content available and whether a content channel is active may be determined based on contextual characteristics of the apparatus 50 and/or the user of the apparatus. Accordingly, in some embodiments the apparatus 50 may include a contextual characteristic determiner 86, which may determine one or more contextual characteristics. Contextual characteristics may include the present time, location, activity, etc. of the user and/or the apparatus 50. The processor 70 may be embodied as, include or otherwise control the contextual characteristic determiner 86. Thus, for example, the contextual characteristic determiner 86 may determine that the user is presently at home, at work, or outside walking. Information relating to the location of the user may, for example, be provided by a GPS module, though location information may additionally or alternatively be provided through other means such as triangulation using cell phone towers in some embodiments. Thus, the apparatus 50 may determine one or more contextual characteristics which may be used to determine whether content relating to the content tags of a content channel is available and/or determine whether the content channel is active based on the selected values of the context tokens associated therewith.

As noted above, the apparatus 50 may include more or less than the components shown in FIG. 2. In this regard, in one example embodiment of the apparatus 50 which is employed on the user terminal 10, the apparatus may comprise the content channel drafting module 78, the content channel suggesting module 84, the contextual characteristic determiner 86 and/or other components. Further, in one example embodiment of the apparatus 50 which is employed on the content channel server 40, the apparatus may comprise the content channel comparison module 80, the channel creation determination module 82, and/or other components. However, the apparatus 50 may vary in other embodiments as may be understood by one having skill in the art. For example, the content channel suggesting module 84 may be partially or fully embodied on the content channel server 40 in some embodiments.

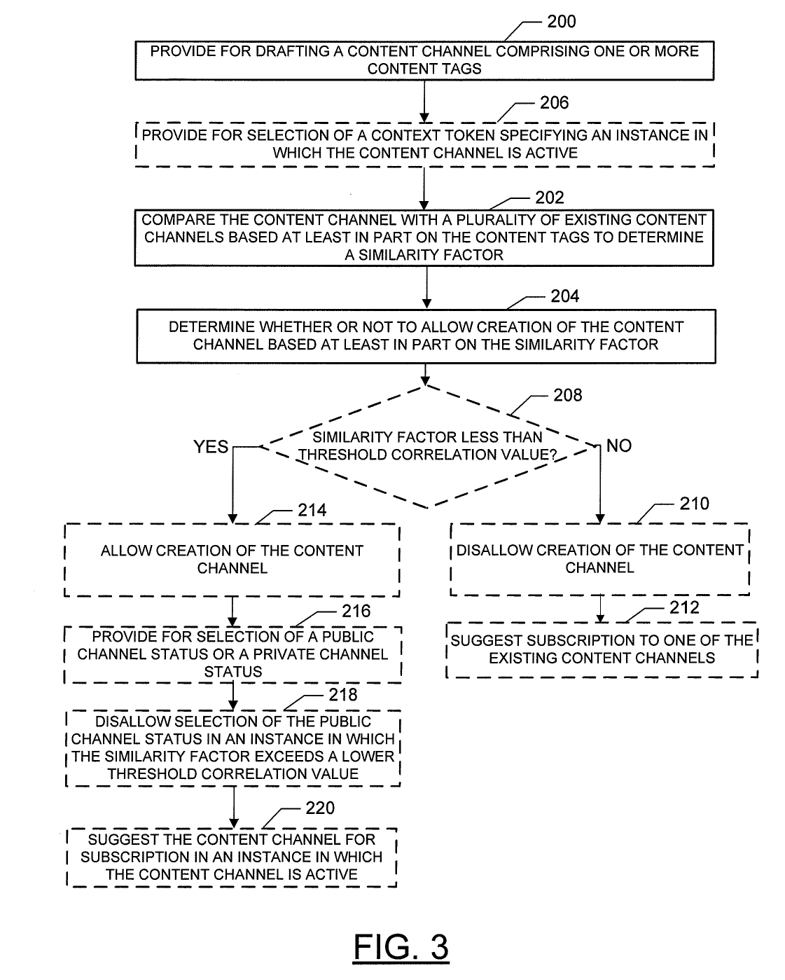

In terms of methods associated with embodiments of the present invention, the above-described apparatus 50 or other embodiments of apparatuses may be employed. In this regard, FIG. 3 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method includes providing for drafting a content channel comprising one or more content tags at operation 200. In embodiments employed on the user terminal 10, the method may include entering the data relating to the content channel, including the content tags. In embodiments employed on the content channel server 40, providing for drafting the content channel may include receiving the data relating to the content channel at the content channel server, which may occur via a specified http signaling method relevant to the content channel server. Further, the method may include comparing the content channel with a plurality of existing content channels based at least in part on the content tags to determine a similarity factor at operation 202. Additionally, the method may include determining whether or not to allow creation of the content channel based at least in part on the similarity factor at operation 204.

In some embodiments, certain ones of the above-described operations (as illustrated in solid lines in FIG. 3) may be modified or further amplified. In some embodiments additional operations may also be included (some examples of which are shown in dashed lines in FIG. 3). It should be appreciated that each of the modifications, optional additions or amplifications may be included with the above-described operations (200-204) either alone or in combination with any others among the features described herein. As such, each of the other operations as will be described herein may be combinable with the above-described operations (200-204) either alone or with one, more than one, or all of the additional operations in any combination.

For example, the method may also include providing for selection of a context token specifying an instance in which the content channel is active at operation 206. Further, in some embodiments the method may depend on whether or not the similarity factor is less than a threshold correlation value, as indicated at decision block 208. Thus, method may further comprise disallowing creation of the content channel at operation 210 in an instance in which the similarity factor exceeds the threshold correlation value. Additionally, the method may include suggesting subscription to one of the existing content channels at operation 212 in the instance in which the similarity factor exceeds the threshold correlation value. Accordingly, creation of a content channel which is substantially similar to an existing content channel may be avoided, while allowing the user the option to subscribe to an existing content channel which relates to the draft content channel.

Conversely, the method may comprise allowing creation of the content channel at operation 214 in an instance in which the similarity factor is less than a threshold correlation value. Hence, the method may allow for the creation of a new content channel when the draft content channel is relatively more unique. In some embodiments the method may also comprise providing for selection of a public channel status configured to allow sharing of the content channel or a private channel status configured to disallow sharing of the content channel at operation 216. Although this operation is illustrated as occurring after the determination of whether the similarity factor is less than the threshold correlation value at operation 208, in other embodiments selection of public or private channel status at operation 216 may occur prior to this determination. However, in some embodiments the method may further comprise disallowing selection of the public channel status in an instance in which the similarity factor exceeds a lower threshold correlation value at operation 218. Accordingly, relatively less unique content channels may not be allowed to have public channel status in some embodiments. Also, when the method allows for creation of the content channel at operation 214, the method may further include suggesting the content channel for subscription in an instance in which the content channel is active, as indicated at operation 220. Thus, a user may subscribe to the content channel.

In an example embodiment, an apparatus for performing the method of FIG. 3 and other methods described above may comprise a processor (for example, the processor 70) configured to perform some or each of the operations (200-220) described above. The processor may, for example, be configured to perform the operations (200-220) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-220 may comprise, for example, the processor 70, the user interface 72, the communication interface 74, the content channel drafting module 78, the content channel comparison module 80, the channel creation determination module 82, the content channel suggesting module 84, and/or the contextual characteristic determiner 86, as described above. However, the above-described portions of the apparatus 50 as they relate to the operations of the method illustrated in FIG. 3 are merely examples, and it should be understood that various other embodiments may be possible.

In some embodiments the operation 200 of providing for drafting a content channel comprising one or more content tags and the operation 206 of providing for selection of a context token specifying an instance in which the content channel is active may be conducted by means, such as the content channel drafting module 78, the user interface 72, and/or the processor 70. Further, the operation 202 of comparing the content channel with a plurality of existing content channels based at least in part on the content tags to determine a similarity factor may be conducted by means, such as the content channel comparison module 80, and/or the processor 70. Additionally, the operation 204 of determining whether or not to allow creation of the content channel based at least in part on the similarity factor, the operation 210 of disallowing creation of the content channel in an instance in which the similarity factor exceeds the threshold correlation value, and the operation 214 of allowing creation of the content channel in an instance in which the similarity factor is less than a threshold correlation value may be conducted by means, such as channel creation determination module 82, and/or the processor 70.

Also, the operation 212 of suggesting subscription to one of the existing content channels may be conducted by means, such as the content channel suggesting module 84, and/or the processor 70. Additionally, the operation 216 of providing for selection of a public channel status or a private channel status and the operation 218 of disallowing selection of the public channel status in an instance in which the similarity factor exceeds a lower threshold correlation value may be conducted by means, such as the content channel drafting module 78, the content channel comparison module 80, the channel creation determination module 82, and/or the processor 70. Further, the operation 220 of suggesting the content channel for subscription in an instance in which the content channel is active may be conducted by means, such as content channel suggesting module 84, the contextual characteristic module 86, and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one memory including computer program code, the at least one memory and the computer program code configured to, with the processor, cause the apparatus to:
provide for drafting a content channel comprising one or more content tags;
compare the content channel with a plurality of existing content channels based at least in part on the content tags to determine a similarity factor; and
determine whether or not to allow creation of the content channel based at least in part on the similarity factor.

2. The apparatus of claim 1, further configured to:
allow creation of the content channel in an instance in which the similarity factor is less than a threshold correlation value; and
disallow creation of the content channel in an instance in which the similarity factor exceeds the threshold correlation value.

3. The apparatus of claim 2, further configured to provide for selection of a public channel status configured to allow sharing of the content channel or a private channel status configured to disallow sharing of the content channel.

4. The apparatus of claim 3, further comprising disallowing selection of the public channel status in an instance in which the similarity factor exceeds a lower threshold correlation value.

5. The apparatus of claim 2, further configured to suggest subscription to one of the existing content channels in the instance in which the similarity factor exceeds the threshold correlation value.

6. The apparatus of claim 1, further configured to provide for selection of a context token specifying an instance in which the content channel is active.

7. The apparatus of claim 1, further comprising user interface circuitry configured to:
facilitate user control of at least some functions of the apparatus through use of a display; and
cause at least a portion of a user interface of the apparatus to be displayed on the display to facilitate user control of at least some functions of the apparatus.

8. A method, comprising:
providing for drafting a content channel comprising one or more content tags;
comparing the content channel with a plurality of existing content channels based at least in part on the content tags to determine a similarity factor; and
determining via a processor whether or not to allow creation of the content channel based at least in part on the similarity factor.

9. The method of claim 8, further comprising:
allowing creation of the content channel in an instance in which the similarity factor is less than a threshold correlation value; and
disallowing creation of the content channel in an instance in which the similarity factor exceeds the threshold correlation value.

10. The method of claim 9, further comprising providing for selection of a public channel status configured to allow sharing of the content channel or a private channel status configured to disallow sharing of the content channel.

11. The method of claim 10, further comprising disallowing selection of the public channel status in an instance in which the similarity factor exceeds a lower threshold correlation value.

12. The method of claim 9, further comprising suggesting subscription to one of the existing content channels in the instance in which the similarity factor exceeds the threshold correlation value.

13. The method of claim 8, further comprising providing for selection of a context token specifying an instance in which the content channel is active.

14. The method of claim 13, further comprising suggesting the content channel for subscription in an instance in which the content channel is active.

15. A computer program product comprising at least one computer-readable storage medium having computer-executable program code portions stored therein, the computer-executable program code portions comprising:
program code instructions providing for drafting a content channel comprising one or more content tags;
program code instructions for comparing the content channel with a plurality of existing content channels based at least in part on the content tags to determine a similarity factor; and
program code instructions for determining whether or not to allow creation of the content channel based at least in part on the similarity factor.

16. The computer program product of claim 15, further comprising:
program code instructions for allowing creation of the content channel in an instance in which the similarity factor is less than a threshold correlation value; and
program code instructions for disallowing creation of the content channel in an instance in which the similarity factor exceeds the threshold correlation value.

17. The computer program product of claim 16, further comprising program code instructions providing for selection of a public channel status configured to allow sharing of the content channel or a private channel status configured to disallow sharing of the content channel.

18. The computer program product of claim 17, further comprising program code instructions for disallowing selection of the public channel status in an instance in which the similarity factor exceeds a lower threshold correlation value.

19. The computer program product of claim 16, further comprising program code instructions for suggesting subscription to one of the existing content channels in the instance in which the similarity factor exceeds the threshold correlation value.

20. The computer program product of claim 15, further comprising program code instructions providing for selection of a context token specifying an instance in which the content channel is active.
